(19) United States
(12) Patent Application Publication
(10) Pub. No.: US 2013/0224496 A1
(43) Pub. Date: Aug. 29, 2013

(54) High Hardness Low Surface Energy Coating

(71) Applicants: Duane R. Palmateer, Middle Grove, NY (US); John A. Kilgour, Port Charlotte, FL (US)

(72) Inventors: Duane R. Palmateer, Middle Grove, NY (US); John A. Kilgour, Port Charlotte, FL (US)

(73) Assignee: Hardcoat Surfaces LLC, Saratoga Spring,, NY (US)

(21) Appl. No.: 13/882,199

(22) PCT Filed: Oct. 29, 2011
(86) PCT No.: PCT/US11/58488

§ 371 Date: Apr. 28, 2013

Related U.S. Application Data
(60) Provisional application No. 61/408,458, filed on Oct. 29, 2010.

(51) Int. Cl. C09D 163/00

(52) U.S. Cl. CPC C09D 163/00
USPC 428/413; 427/386; 523/435; 523/425

(57) ABSTRACT

The present invention is directed to the surprising discovery that a hard, low energy epoxysilicone/organic epoxy coating can be generated that can be easily sanded, easily repaired and are chemically stable to the marine environment. The invention reveals the use of epoxy functional siloxanes that chemically bond with an organic epoxy polymer and a polyfunctional amine or amide to form block copolymer networks with the silicone distributed through the entire matrix. The coating thus generated can be applied directly over most hull substrates, anticorrosion coatings or as a repair over itself.

### FIELD OF THE INVENTION

The present teachings generally relate to high hardness, low surface energy coatings for marine and other aqueous environments. The present teachings more specifically relate to coatings made by curing blends of organic epoxy and epoxysiloxane polymers with polyaminofunctional compounds that provides a superior coating for applications in marine and other aqueous environments. Alternatively, the present teachings more specifically relate to coatings made by curing blends of organic epoxy and epoxysiloxane polymers with polyaminofunctional compounds that provides a superior coating for applications in non-aqueous or non-marine environments.

### BACKGROUND

A wide range of surfaces such as ships hulls, floating oil drilling rigs, water intakes in power plants, and the like function in marine environments. As such they are constantly subjected to a myriad of types of marine life. A variety of these marine life forms are capable of attaching to the surface resulting in problems such as slowing ship speed and increasing fuel consumption, increasing weight and reducing buoyancy, plugging intake and cooling systems and similar problems related to massive growth build-up. Thus ever since ships took to the sea, coatings have been sought that eliminate the attachment of marine organisms to the hull.

Generally, presently available silicone coatings disadvantageously have a soft silicone top coat generally through the polymerization of silanol terminated, alkoxy terminated or a blend thereof in the presence of a catalyst, often an undesirable tin compound. Regardless of how they are generated they have significant disadvantages in their use as coatings.

Firstly, there is a disadvantageous need to use an intervening “tie coating” to adhere the silicone coating to the desired surface. This is particularly true where for example epoxy coatings have been used to coat a steel hull to prevent corrosion of the steel. This need for an intermediate coating adds significant time and expanse to coating the hull. The tie coating is then coated with the silicone coating. The silicone coating is relatively thin and soft and thus damaged through abrasion or collision. Once damaged it is very difficult to repair as a new silicone coating may not adhere well to the existing surface. Further, because it is thin and soft, it cannot be sanded or smoothed after curing to lower the surface resistance to the water during cruising. Silicone coatings of these patents depend on some of their release characteristics coming from silicone oligomers and polymers that are not chemically bound. Thus over time these components elute out of the coating and the coating's effectiveness decreases.

Silicone polymers have been blended with fluorocarbons to further lower the surface energy. They are added as unreactive materials that do not chemically bind into the silicone polymer network. Over time they will come to the surface and elute away from the coating to become ineffective.

A coating made of a silanol terminated siloxane, an organic epoxide and an amine curative compound has been provided to help harden the silicone coating. The terminal silanol is generated from the group including SiOH, SiOR and SiCl, which generate SiOH in situ. The silanol terminated materials may or may not react with OH functional groups on the organic epoxide after they have reacted with the amine curative. If they react, SiOR bonds are generated as the only means of reacting the loose silicone into the polymer matrix. Even if formed, the SiOR bonds are subject to hydrolysis, so over time, in the presence of water from the marine environment, the SiOR bonds will break, releasing the silicone polymer from the network. The result is that over time the silicone elutes from the coating and the release performance declines. Further, the free silicone in the coating can migrate to the surface during the curing process. As a result the outer layer of the coating is rich in silicone and cannot be sanded as a significant amount of the silicone is removed. These coatings are further restricted in their performance by the use of only terminally functional siloxanes which are chain extenders in the polymer network. While those at the surface control the surface energy, those still in the matrix weaken the network structure by long flexible chains of silicone between crosslink points. This lowers the hardness and decreases the abrasion resistance. A weakening that is exacerbated when the SiOR bonds are broken by water.

### BRIEF DESCRIPTION OF THE FIGURES

FIG. 1 depicts a flow diagram of a method of containing a substrate, in accordance with embodiments of the present invention.

### SUMMARY OF THE INVENTION

The present teachings are directed to the surprising discovery that a hard, low energy epoxypolysiloxane/organic epoxy coating can be generated that can be easily sanded, easily repaired and are chemically stable to the marine environment. The epoxypolysiloxane must have at least two silicone atoms joined by an oxygen atom. The epoxy resin does may not include epoxy resins made from an alkoxysilane, e.g. The invention reveals the use of epoxy functional siloxanes that chemically bond with an organic epoxy polymer and a polyfunctional amine or amide to form block copolymer networks with the silicone distributed through the entire matrix. The coating thus generated can be applied directly over most hull substrates, anticorrosion coatings or as a repair over itself.

A first aspect of the present invention provides a coating, comprising: 1-99 parts of an organic epoxy; 99-1 parts of an alkylepoxysiloxane II, and 1-50 parts of a curing agent. The epoxy siloxane of this invention is an epoxy substituted siloxane composed of two or more silicons joined by oxygen and containing an epoxy functional group joined to the silicon via a silicon/carbon bond. The siloxane may be linear, branched or highly branched. The epoxy functional group may be attached terminally and/or as a pendant to the siloxane. The structure of the epoxy siloxane is alkylepoxysiloxane II, having the following structure (II):

(R¹R²R³SiO_{1/2})ₐ(R⁴R⁵R⁶SiO_{1/2})_{b}(R⁷R⁸SiO_{2/2})_{c}(R⁹R¹⁰SiO_{2/2})_{d}(R¹¹SiO_{3/2})ₑ(R¹²SiO_{3/2})_{f}(SiO_{4/4})_{g} (II)

Each R¹ to R¹² is independently a hydrogen atom, an alkyl group containing 1-30 carbon atoms, an aryl group, an alkaryl group containing 1-30 carbons, and an CHR¹³OCR¹⁴R¹⁵ group. At least one R¹ and R¹² is CHR¹³OCR¹⁴R¹⁵, and R¹³ independently an alkylene group of 1 to 30 carbons, or one or more hetero atoms such as oxygen, sulfur, or nitrogen, and each R¹⁴, and R¹⁵ is independently a hydrogen atom, an alkyl group or an aryl group; or R¹³ and either R¹⁴ or R¹⁵ are linked to form a three- to eight-membered cyclic group, wherein a through g are each individually 0 to 200, and a+b+c+d+e+f+g≧2.

A second aspect of the present invention provides a method for coating a substrate, comprising: blending an epoxy siloxane, an epoxy organic compound and an amine or amide compound; coating a substrate with the blend; and curing the coating.

### DETAILED DESCRIPTION OF THE EMBODIMENTS OF THE INVENTION

The present teachings are directed to a coating that be easily applied to a variety of marine surfaces, e.g., to ship hulls, propellers, oil rigs' underpinnings and other underpinnings of stationary floating structures for foul release; to sailing ships', canoes', kayaks', row boats' hulls, surf boards, and paddle boards to lower drag and increase speed; anti graffiti coatings, wind turbine blades for ice and dirt release; coatings over wood, or over plastics, e.g., polyesters, polyepoxides, polyurethanes and the like, over metals, e.g., aluminum, steel, bronze, titanium and copper.

The coating is advantageously easily cleaned or more desirably self cleaning for example while a boat is underway. The coating are durable enough to survive and perform in a variety of marine environments including for example in warm and cold water, in the presence of oil and other chemicals present on port waters, and under abrasion while cruising or in moderate rubbing contact with tugboats or ship bumpers while docked. As hull damage may be incurred in daily use, the coating is easily repairable through simple recoating over the existing coat under normal coating conditions. The coatings have a low surface energy and are capable of being sanded as a method of providing a smooth surface.

Silicone based polymeric coatings provide a different mechanism for preventing marine organism build up on the ship hull. It has been reported in “Surface behavior of biomaterials: The theta surface for biocompatibility”, J. Mat. Sci. Mater Med (2006) 17:1057-1062, that silicone polymers have a low surface energy between about 20 and 30 mN/m (milli newtons/meter, dynes/cm). As such they should provide coatings with minimal organism attachment, and can be easily cleaned by moderate rubbing, or by traveling through water at moderate speeds (generally over 10 knots). Thus the concept of a self cleaning coating has emerged.

Further, the coating is advantageously chemically stable for a period from greater than or equal to 3 years so that the coating retains its low surface energy between about 17 mN/m and 30 mN/m (milli newtons/meter, dynes/cm) and being capable of being sanded as a method of providing a smooth surface to minimize the attachment of organisms in the presence of water and bound together to avoid degradation through elution of chemicals into the environment.

This invention provides a coating composition comprising an epoxy siloxane, an epoxy organic compound and an amine or amide compound.

### A. Epoxy Siloxane

The epoxy siloxane has an epoxy group that is attached to the siloxane polymer through a Si—C bond such that it is chemically stable especially against hydrolysis in the presence of water. The epoxy siloxane may be attached terminally on the siloxane, and/or as a pendant group along the siloxane polymer. In one embodiment, the epoxy siloxane is blended and polymerized with an organic epoxide and a polyfunctional amine or amide to form a block copolymer coating composition.

This invention also relates to a coating for use on a variety of substrates. The coating is comprised of an epoxy siloxane, an epoxy organic compound and an amine or amide compound that is blended together and then coated onto a substrate where it cures into a block copolymer or interpenetrating network. The coating is especially suited to use in a marine environment for example as a coating on the hull of a ship.

The invention also relates to providing a coating that has an easy release surface especially toward marine organisms that may wish to attach to the coated substrate. The easy release is generally related to the coating providing a low surface energy between 17 and 30 dynes/cm. At such surface energies it is believed that marine organisms have a difficult time holding on and are thus easily cleaned by gentle abrasion such as one my expect from hand washing, power water washing or even rapid movement through water during cruising. The provided coating being capable of withstanding such cleaning.

The epoxy siloxane of this invention is an epoxy substituted siloxane, wherein “siloxane” is defined as a polymer backbone composed of two or more silicon atoms joined by oxygen and containing an epoxy functional group joined to the silicon via a silicon carbon bond. Epoxy siloxane does not include epoxy silane, e.g., glycidyl silane, or any glycidyl functionalized silane in which the silicon atom is not part of a siloxane backbone. Replacement of epoxy siloxane with epoxy silane results in a coating for which the surface energy is greater than 30 dynes/cm, and provides unsatisfactory foul release.

The siloxane may be linear, branched or highly branched. The epoxy functional group may be attached terminally and/or as a pendant to the siloxane. The structure of the epoxy siloxane is alkylepoxysiloxane II, having the following structure (II):

(R¹R²R³SiO_{1/2})ₐ(R⁴R⁵R⁶SiO_{1/2})_{b}(R⁷R⁸SiO_{2/2})_{c}(R⁹R¹⁰SiO_{2/2})_{d}(R¹¹SiO_{3/2})ₑ(R¹²SiO_{3/2})_{f}(SiO_{4/4})_{g} (II)

wherein each R¹ to R¹² are each independently a hydrogen, an alkyl group containing 1-30 carbon atoms, an aryl group, an alkaryl group containing 1-30 carbons, and an CHR¹³OCR¹⁴R¹⁵ group,

wherein at least one R¹ to R¹² is CHR¹³OCR¹⁴R¹⁵, and
R¹³ is independently an alkylene group of 1 to 30 carbons, or one or more hetero atoms such as oxygen, sulfur, or nitrogen, and
each R¹⁴, and R¹⁵ is independently a hydrogen atom, an alkyl group or an aryl group; or
R¹³ and either R¹⁴ or R¹⁵ are linked to form a three- to eight-membered cyclic group,

wherein a through g are each individually 0 to 200, and a+b+c+d+e+f+g≧2.

In one embodiment, CHR¹³OCR¹⁴R¹⁵ is represented by the following structure III:

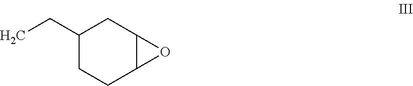

### B. The Organic Epoxy

The organic epoxy may be an organic compound containing an attached, active epoxy group. Alternatively, the organic epoxy may be advantageously an alkylene oxide adduct prepared from compounds containing an average of more than one hydroxyl groups. In one embodiment, the alkylene oxide oxide adduct is produced from reaction of an epihalohydrin and compounds having an average of more than one hydroxyl group. In an alternative embodiment, the alkylene oxide adduct is selected from the group consisting of the reaction products of epichlorohydrin and bisphenol A, epichlorohydrin and phenol, epichlorohydrin and biphenol, epichlorohydrin and an amine, epichlorohydrin and a carboxylic acid, and an epoxide prepared by oxidation of an aliphatic or aromatic olefin or alkyne.

In one embodiment, the alkylene oxide adduct is produced from reaction of an epihalohydrin and compounds selected from the group consisting of aliphatic alcohols, aliphatic diols, polyether diols, polyether triols, polyether tetrols, and combination thereof.

The epoxy resin may be saturated or unsaturated, aliphatic, cycloaliphatic, aromatic, heterocyclic and may be additionally substituted. Alternatively, the epoxy resin may be monomeric, oligomeric or polymeric.

The epoxy resin compound utilized may be, for example, an epoxy resin or a combination of epoxy resins prepared from an epihalohydrin and a phenol or a phenol type compound, prepared from an epihalohydrin and an amine, prepared from an epihalohydrin and a carboxylic acid, or prepared from the oxidation of unsaturated compounds.

In one embodiment, the epoxy resins utilized in the compositions of the present invention include those resins produced from an epihalohydrin and a phenol or a phenol type compound. The phenol type compound includes compounds having an average of more than one aromatic hydroxyl group per molecule. Examples of phenol type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In another embodiment, the epoxy resins utilized in the compositions of the invention preferably include those resins produced from an epihalohydrin and bisphenols, halogenated bisphenols, hydrogenated bisphenols, novolac resins, and polyalkylene glycols, or combinations thereof.

In another embodiment, the epoxy resin compounds utilized in the compositions of the invention preferably include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins, tetramethylbiphenol, tetramethyl-tetrabromobiphenol, tetramethyltribromobiphenol, tetrachlorobisphenol A, or combinations thereof.

The preparation of epoxy resins is well known in the art. See Kirk-Othmer, Encyclopedia of Chemical Technology, 3rd Ed., Vol. 9, pp 267-289. Examples of epoxy resins and their precursors suitable for use in the compositions of the invention are also described, for example, in U.S. Pat. Nos. 5,137,990 and 6,451,898 which are incorporated herein by reference.

In another embodiment, the epoxy resins utilized in the compositions of the present invention include those resins produced from an epihalohydrin and an amine. Suitable amines include diaminodiphenylmethane, aminophenol, xylene diamine, anilines, and the like, or combinations thereof.

In another embodiment, the epoxy resins utilized in the compositions of the present invention include those resins produced from an epihalohydrin and a carboxylic acid. Suitable carboxylic acids include phthalic acid, isophthalic acid, terephthalic acid, tetrahydro- and/or hexahydrophthalic acid, endomethylenetetrahydrophthalic acid, isophthalic acid, methylhexahydrophthalic acid, and the like or combinations thereof.

In another embodiment, the epoxy resin compounds utilized in the compositions of the invention include those resins produced from an epihalohydrin and compounds having at least one aliphatic hydroxyl group. In this embodiment, it is understood that such resin compositions produced contain an average of more than one aliphatic hydroxyl groups.

Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such resin compositions produced contain an average of more than one aromatic hydroxyl groups. Examples of oxide adducts of compounds containing at least one aromatic hydroxyl group per molecule include ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

In another embodiment, the epoxy resin refers to an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon, which is described herein as a compound having a hydrocarbon backbone, preferably a C₁₀-C₄₀ hydrocarbon backbone, and one or more carboxyl moieties, preferably more than one, and most preferably two. The C₁₀-C₄₀ hydrocarbon backbone may be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, VERSATIC™ acids, available from Resolution Performance Products LLC, Houston, Tex., decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In another embodiment, the epoxy resin is the reaction product of a polyepoxide and a compound containing more than one isocyanate moiety or a polyisocyanate. Preferably the epoxy resin produced in such a reaction is an epoxy-terminated polyoxazolidone.

### C. Curing Agents.

In one embodiment, the curing agents utilized in the compositions of the invention include amine- and amide-containing curing agents having, on average, more than one active hydrogen atom, wherein the active hydrogen atoms may be bonded to the same nitrogen atom or to different nitrogen atoms. Examples of suitable curing agents include those compounds that contain a primary amine moiety, and compounds that contain two or more primary or secondary amine or amide moieties linked to a common central organic moiety. Examples of suitable amine-containing curing agents include ethylene diamine, diethylene triamine, polyoxypropylene diamine, triethylene tetramine, dicyandiamide, melamine, cyclohexylamine, benzylamine, diethylaniline, methylenedianiline, m-phenylenediamine, diaminodiphenylsulfone, 2,4 bis(p-aminobenzyl)aniline, piperidine, N,N-diethyl-1,3-propane diamine, and the like, and soluble adducts of amines and polyepoxides and their salts, such as described in U.S. Pat. Nos. 2,651,589 and 2,640,037, herein incorporated by reference.

In another embodiment, polyamidoamines may be utilized as a curing agent in the resin compositions of the invention. Polyamidoamines are typically the reaction product of a polyacid and an amine. Examples of polyacids used in making these polyamidoamines include 1,10-decanedioic acid, 1,12-dodecanedioic acid, 1,20-eicosanedioic acid, 1,14-tetradecanedioic acid, 1,18-octadecanedioic acid and dimerized and trimerized fatty acids. Amines used in making the polyamidoamines include aliphatic and cycloaliphatic polyamines such as ethylene diamine, diethylene triamine, triethylene tetramine, tetraethylene pentamine, 1,4-diaminobutane, 1,3-diaminobutane, hexamethylene diamine, 3-(N-isopropylamino)propylamine and the like. In another embodiment, polyamides are those derived from the aliphatic polyamines containing no more than 12 carbon atoms and polymeric fatty acids obtained by dimerizing and/or trimerizing ethylenically unsaturated fatty acids containing up to 25 carbon atoms.

In another embodiment, the curing agents are aliphatic polyamines, polyglycoldiamines, polyoxypropylene diamines, polyoxypropylenetriamines, amidoamines, imidazoles, reactive polyamides, ketimines, araliphatic polyamines (i.e. xylylenediamine), cycloaliphatic amines (i.e. isophoronediamine or diaminocyclohexane), menthane diamine, 4,4-diamino-3,3-dimethyldicyclohexylmethane, heterocyclic amines (aminoethyl piperazine), aromatic polyamines (methylene dianiline), diamino diphenyl sulfone, mannich base, phenalkamine, N,N′,N″-tris(6-aminohexyl)melamine, and the like. In another embodiment, imidazoles, which may be utilized as an accelerator for a curing agent, may also be utilized as a curing agent.

In another embodiment, the curing agent is a phenolic curing agent which includes compounds having an average of one or more phenolic groups per molecule. Suitable phenol curing agents include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, phenol-aldehyde novolac resins, halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof. Preferably, the phenolic curing agent includes substituted or unsubstituted phenols, biphenols, bisphenols, novolacs or combinations thereof.

In another embodiment, the curing agent is a polybasic acid or its corresponding anhydride. Examples of polybasic acids include di-, tri-, and higher carboxylic acids, such as, oxalic acid, phthalic acid, terephthalic acid, succinic acid, alkyl and alkenyl-substituted succinic acids and tartaric acid. Examples also include polymerized unsaturated acids, for example, those containing at least 10 carbon atoms, and preferably more than 14 carbon atoms, such as, dodecenedioic acid, and 10,12-eicosadienedioic acid. Examples of suitable anhydrides include phthalic anhydride, succinic anhydride, maleic anhydride, nadic anhydride, nadic methyl anhydride, pyromellitic anhydride, trimellitic anhydride and the like. Other types of acids that are useful are those containing sulfur, nitrogen, phosphorus or halogens; chlorendic acid, benzene phosphonic acid, and sulfonyl dipropionic acid bis(4-carboxyphenyl)amide.

The ratio of curing agent to epoxy resin is preferably suitable to provide a fully cured resin. The amount of curing agent which may be present may vary depending upon the particular curing agent used (due to the cure chemistry and curing agent equivalent weight) as is known in the art.

The organic epoxy, the epoxysiloxane and the polyaminofunctional components may be emulsified in water before delivery as a blend for coating. In one embodiment. surfactants such as, for example, non-ionic surfactants, may be admixed into the water, as emulsifying agents, to facilitate emulsification of the organic epoxy, the epoxysiloxane and the polyaminofunctional components in water before delivery as a blend for coating. Non-ionic surfactants that may be used as emulsifying agents are:
Fatty alcohols:
   Cetyl alcohol,
   Stearyl alcohol,
   Cetostearyl alcohol (consisting predominantly of cetyl and stearyl alcohols),
   Oleyl alcohol;
Polyoxyethylene glycol alkyl ethers: CH₃—(CH₂)₁₀₋₁₆—(O—C₂H₄)₁₋₂₅—OH:
   Octaethylene glycol monododecyl ether,
   Pentaethylene glycol monododecyl ether;
Polyoxypropylene glycol alkyl ethers: CH₃—(CH₂)₁₀₋₁₆—(O—C₃H₆)₁₋₂₅—OH;
Glucoside alkyl ethers: CH₃—(CH₂)₁₀₋₁₆—(O-Glucoside)₁₋₃-OH:
   Decyl glucoside,
   Lauryl glucoside,
   Octyl glucoside;
Polyoxyethylene glycol octylphenol ethers: C₈H₁₇—(C₆H₄)—(O—C₂H₄)₁₋₂₅—OH:
   Triton X-100;
Polyoxyethylene glycol alkylphenol ethers: C₉H₁₉—(C₆H₄)—(O—C₂H₄)₁₋₂₅—OH:
   Nonoxynol-9;
Glycerol alkyl esters:
   Glyceryl laurate
Polyoxyethylene glycol sorbitan alkyl esters: Polysorbates;
Sorbitan alkyl esters: Spans;
Cocamide MEA, cocamide DEA;
Dodecyl dimethylamine oxide;
Block copolymers of polyethylene glycol and polypropylene glycol: Poloxamers . . .
Silicone surfactants, e.g. polyepoxy, polypropoxysilicone block co-polymers.

Normally the organic and siloxane epoxy are emulsified in water individually and then blended to a single emulsion for coating, or emulsified into a single emulsion. The nitrogen bearing component may be emulsified or directly blended with the epoxy components and applied to the substrate.

In one embodiment, at least one of the organic epoxy ingredient, the siloxane epoxy ingredient and the curing agent ingredient has been emulsified with water prior to being directly blended with the other ingredients and being applied to a substrate.

In one embodiment, the organic epoxy and siloxane epoxy are emulsified in water, and the curing agent has been blended directly into the epoxy and siloxane epoxy emulsion.

In one embodiment, the curing agent is emulsified in water prior to being mixed with the epoxy and siloxane epoxy emulsion or the curing agent is directly blended with the epoxy and siloxane epoxy emulsion.

This invention also relates to optional inclusion of materials that are deterrents to the attachment and growth of marine organisms. Such materials might include metals such as copper or zinc, organic biocides and deterrents such as organic or bio-organic compounds that inhibit or discourage the growth or initiation of growth and attachment of organisms to the coating.

The following examples are illustrative of the low surface energy coatings of the present teachings, and are not intended in any way to limit their scope.

### EXAMPLES 1-9

Sample hardness was tested using a Gardco 5021 Pencil Hardness tester with a range of pencils from softest 6B, to midrange F, to the hardest at 9H. The testing was done in accordance to ASTM D3363.

Relative surface energy was measured using a Roll-Off-Angle test. 100 microliters of water was place on the sample. The sample was then slowly tilted until the water bead rolled lower on the surface. A lower angle at the time of roll-off indicates a lower surface energy. At lower surface energy the ability and interest of marine organisms to anchor to the surface is reduced and cleaning is easier.

In-water testing for marine growth and sample cleaning was done in Punta Gorda, Fla., where sea growth is very active, with a variety of organisms aggressively trying to attach to any surface. Samples were placed on a rack and lowered into the water facing the sun. They were removed and rated at regular intervals to evaluate marine growth and ease of cleaning.

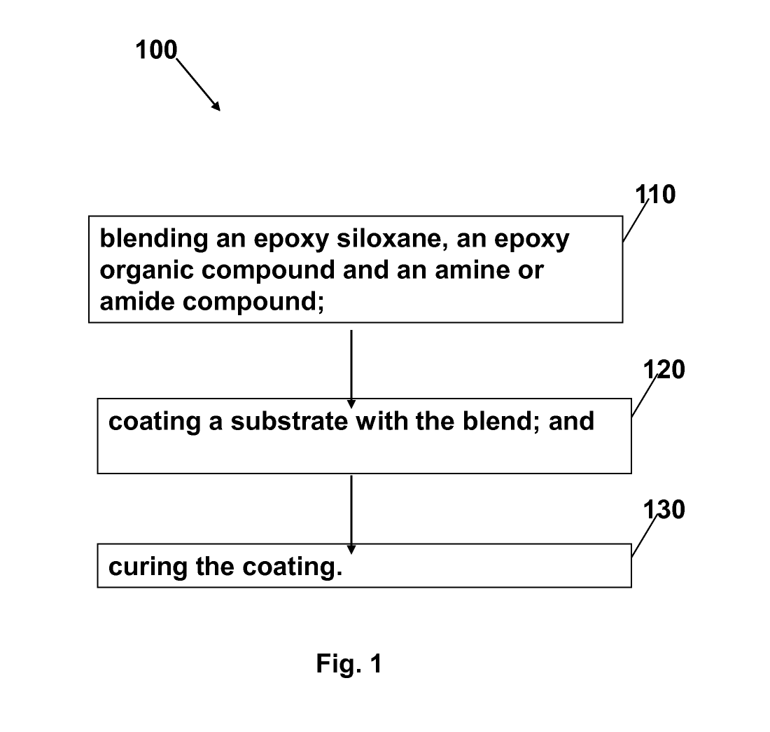

FIG. 1 depicts a method 100 for coating a substrate, comprises a step 110: blending an epoxy siloxane, an epoxy organic compound and an amine or amide curing agent. In a step 120 of the method 100, this reactive solution was coated onto an aluminum coupon and allowed to cure at room temperature in a step 130 of the method 100. The coated coupon was then immersed in the ocean at Punta Gorda, Fla. Exemplary formulations and results are described in the following Examples 1-9.

In one embodiment of the method 100, the substrate is the hull of a ship.

In one embodiment of the method 100, the cured coating is a hard, low energy epoxypolysiloxane/organic epoxy coating that is sandable.

In one embodiment of the method 100, the cured coating is a hard, low energy epoxypolysiloxane/organic epoxy coating that is repairable.

In one embodiment of the method 100, the cured coating is a hard, low energy epoxypolysiloxane/organic epoxy coating that is chemically stable to the marine environment.

In one embodiment of the method 100, the cured coating is a hard, low energy epoxypolysiloxane/organic epoxy coating that is a block copolymer or interpenetrating network.

In one embodiment, the method 100 comprises emulsifying at least one of the organic epoxy ingredient, the siloxane epoxy ingredient and the curing agent ingredient with water prior to being directly blended with the other ingredients and being applied to a substrate.

In one embodiment, the method 100 comprises emulsifying the organic epoxy and siloxane epoxy in water, and blending the curing agent directly into the epoxy and siloxane epoxy emulsion.

In one embodiment, the method 100 comprises emulsifying the curing agent in water prior to being mixed with the epoxy and siloxane epoxy emulsion or directly blending the curing agent with the epoxy and siloxane epoxy emulsion.

The following examples are exemplary examples of high hardness, low surface energy coatings, not mean to limit the scope of the present invention.

### Example 1

233.4 grams of an alkoxylated bis-phenol A epoxy resin dispersed in water (solids epoxy equivalent weight 520), 62.4 grams of a variable molecular weight epoxide-functional polydimethylsiloxane copolymer designed for use as a photocurable release agent (UV 9400) from Momentive Performance Materials, 9.4 grams of an aqueous mixture of chlorinated paraffin resin (Doversperse A-1) from Dover Chemical Corporation, 11.8 grams of filler (Yunite V-2) from Arclay LLC, 18.8 grams of Propoxy Ethanol, 3.8 grams of coloring (phthalo blue) from Plasticolours, 27.8 grams of water and 1.25 grams of polyether modified polydimethylsiloxane (BYK 333) from BYK USA inc. were blended to form an emulsion. 62.5 grams of this solution was mixed with 15.8 grams of a blend of an amine or amide curing agent (EpiKure 8290-Y-60) from Hexion Specialty Corporation and water that had been blended in a 75 to 15 ratio.

This reactive solution was coated onto an aluminum coupon and allowed to cure at room temperature. The coated coupon was then immersed in the ocean at Punta Gorda Fla. Results are shown in Table 1C.

### Example 2

233.4 grams of an alkoxylated bis-phenol A epoxy resin dispersed in water (solids epoxy equivalent weight 520), 62.4 grams of an epoxide-functional polydimethylsiloxane copolymer designed for use as a photocurable release agent (UV 9400™) from Momentive Performance Materials, 9.4 grams of Doversperse A-1™ from Dover Chemical Corporation, 11.8 grams of Yunite V-2 from Arclay LLC, 18.8 grams of Propoxy Ethanol, 3.8 grams of phthalo blue from Plasticolours, 27.8 grams of water and 0.75 grams of Novec FC-4430™ from 3M were blended to form an emulsion. 62.5 grams of this solution was mixed with 15.8 grams of a blend of EpiKure 8290-Y-60™ from Hexion Specialty Corporation and water that had been blended in a 75 to 15 ratio.

This reactive solution was coated onto an aluminum coupon and allowed to cure at room temperature. The coated coupon was then immersed in the ocean at Punta Gorda Fla. Results are shown in Table I.

TABLE I

| Sample | Month 1 | Month 2 | Month 3 |
|---|---|---|---|
| Example 1 | Clean | Some | Heavy |
| | | Barnacles | Barnacles |
| | | Easily | Easily |
| | | Cleaned | Cleaned |
| Example 2 | Clean | Some | Heavy |
| | | Barnacles | Barnacles |
| | | Easily | Easily |
| | | Cleaned | Cleaned |
| Control Aluminum | Heavy growth of barnacles | | |
| Coupon | and vegetation | | |
| | Not cleanable | | |

### Example 3

62.25 grams of an alkoxylated bis-phenol A epoxy resin dispersed in water (solids epoxy equivalent weight 520), 16.65 grams of 3-epoxy cyclohexyl ethyl terminated polydimethylsiloxane (eq. wt. 950), 3.0 grams of yellow 151 from Plasticolours, 1.0 gram of a primary crosslinkable polydialkylsiloxane (DC-3-0133) from Dow Corning, 2.0 grams of fumed silica dispersion (Aerodisp W740X) from Evonik Industries, 14.6 grams of water and 0.5 grams of polyether modified polydimethylsiloxane (BYK 333) from BYK USA Inc. were blended to form an emulsion. 100 grams of this solution was mixed with 25 grams of a solution of an amine or amide curing agent (EpiKure 8290-Y-60) from Hexion Specialty Corporation and water that had been blended in a 75 to 15 ratio.

The solution was sprayed onto a polyester coated fiberglass panels. One half of the coated panel was then sanded with 220 grit sand paper. The panels were then immersed in the ocean at Punta Gorda Fla. The results are shown in Table II.

TABLE II

| Sample | Month 1 | Month 2 |
|---|---|---|
| Unsanded | cleaned easily | cleaned easily |
| Sanded | cleaned easily | cleaned easily |

Pencil Hardness

| | |
|---|---|
| | >14 days |
| Unsanded | F |
| Sanded | F |

Surface Energy by Roll-Off-Angle

| | |
|---|---|
| | Roll-Off-Angle |
| Unsanded | 18.3 |
| Sanded | 18.3 |

The results show that the sanded and unsanded surfaces were both hard and had low surface energies. Because of this the panels were easily cleaned. This demonstrates that the coating contains silicone anchored throughout the bulk of the coating. Thus sanding or other abrasion does not reduce the performance of the coating in providing easy release.

### Example 4

Coatings were formulated using an alkoxylated bis-phenol A epoxy resin dispersed in water (solids epoxy equivalent weight 520), polyether modified polydimethylsiloxane (BYK 333), phthaloblue from Plasticolours, Water, epoxide-functional polydimethylsiloxane copolymer designed for use as a photocurable release agent (UV 9300 available from Momentive Specialty Chemicals, and varied silicones as shown in Table III.

TABLE III

| Formula | A | B | C | D | E | F |
|---|---|---|---|---|---|---|
| Epoxy Resin | 62.3 | 56.1 | 74.8 | 62.3 | 62.3 | 62.3 |
| polyether modified | 0.5 | 0.5 | 0.5 | 0.5 | 0.5 | 0.5 |
| polydimethylsiloxane | | | | | | |
| (BYK 333) | | | | | | |
| Phthalo blue | 1.0 | 1.0 | 1.0 | 1.0 | 1.0 | 1.0 |
| Water | 19.6 | 22.4 | 13.7 | 19.6 | 19.6 | 19.6 |
| epoxide-functional | 16.7 | | | | | |
| polydimethylsiloxane | | | | | | |
| epoxide-functional | | 20.0 | | | | |
| polydimethylsiloxane | | | | | | |
| epoxide-functional | | | 10.0 | | | |
| polydimethylsiloxane | | | | | | |
| M^{ep}D₂₅M^{ep} | | | | 16.7 | | |
| M^{ep}D₂^{ep}D₂₅M^{ep} | | | | | 16.7 | |
| M^{ep}Dₑₚ³D₂₅M^{ep} | | | | | | 16.7 |

Where M^{EP} = 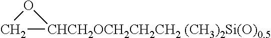
Where D^{EP} = 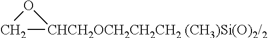
Where D = (CH₃)₂SiO_{2/2}

100 grams of each formula was then blended in two different concentrations with a 50% solution of Epi-Kure 8290 as shown in Table IV.

TABLE IV
Blended formulations

| | Formula | | | | | |
|---|---|---|---|---|---|---|
| | A | B | C | D | E | F |
| Concentration 1 | 27.7 | 27.0 | 29.1 | 26.8 | 31.0 | 32.7 |
| Concentration 2 | 23.1 | — | 24.3 | 22.3 | 25.8 | 27.3 |

The blends were then coated onto an aluminum plate and allowed to cure at room temperature. Pencil hardness was then measured according to ASTM D3363 over time with the results shown in Table V.

TABLE V
Pencil Hardness

| Formula | Day 1 | Day 6 | Day 9+ |
|---|---|---|---|
| A1 | | HB | HB |
| A2 | | 3B | B |
| B1 | | HB | HB |
| C1 | | 4B | HB |
| C2 | | 3B | HB |
| D1 | 4B | | HB |
| D2 | 3B | | HB |
| E1 | 4B | | HB |
| E2 | 3B | | HB |
| F1 | 3B | | HB |
| F2 | 4B | | HB |
| Silicone Release Coating | | | Softer than 6B |

The results show initial cure to be significantly harder than the silicone release coating. Over a relatively short period of time the cure continues to an even harder surface. In contrast, Table VI lists results showing the silicone release coating is soft and easily damaged by abrasion or even very light sanding.

TABLE VI
Surface Energy by Roll-Off-Angle

| Sample | Roll-Off-Angle |
|---|---|
| A1 | 15.8 |
| A2 | 18.3 |
| B1 | 15.8 |
| C1 | 18.3 |
| C2 | 19.2 |
| D1 | 18.3 |
| D2 | 19.2 |
| E1 | 15.8 |
| E2 | 15.8 |
| F1 | 15.8 |
| F2 | 20.9 |
| Silicone Release Coating | 17.5 |

The results show that the epoxysilicone/epoxy resin coatings have low surface energies and thus easy foul release.

### Example 5

Coatings were formulated using an alkoxylated bis-phenol A epoxy resin dispersed in water (solids epoxy equivalent weight 520), polyether modified polydimethylsiloxane (BYK 333), phthalo blue from Plasticolours, Water, Novacite L337 401v, Doversperse A1, Paroil 63NR (both from Dover Chemical Co) and varied silicones as shown in Table VII.

TABLE VII

| | Formula | | | | | | |
|---|---|---|---|---|---|---|---|
| | G | H | I | J | K | L | M |
| epoxy resin | 62.3 | 62.3 | 62.3 | 62.3 | 62.3 | 62.3 | 62.3 |
| polyether modified | 0.5 | 0.5 | 0.5 | 0.5 | 0.5 | 0.5 | 0.5 |
| polydimethyl- | | | | | | | |
| siloxane | | | | | | | |
| Phthalo blue | 1.0 | 1.0 | 1.01.0 | 1.0 | 1.0 | 1.0 | 1.0 |
| Water | 15.5 | 15.5 | 15.5 | 15.5 | 15.5 | 12.5 | 9.5 |
| Novacite L337 | 6.0 | 6.0 | 6.0 | 6.0 | 6.0 | 9.0 | 12.0 |
| 401V | | | | | | | |
| Doversperse A-1 | 5.0 | 5.0 | 5.0 | 5.0 | 5.0 | 5.0 | 5.0 |
| Paroil 63NR | 1.0 | 1.0 | 1.0 | 1.0 | 1.0 | 1.0 | 1.0 |
| M^{ep}D₂₅M^{ep} | 16.7 | | | | | | |
| M^{ep}D^{ep}₂D₂₅M^{ep} | | 16.7 | | | | | |
| M^{ep}D^{ep}₃D₁₅M^{ep} | | | 16.7 | | | | |
| M^{ep}D^{ep}₃D₁₅M^{ep} | | | | 16.7 | | | |
| M^{ep}D^{ep}₃D₁₅M^{ep} | | | | | 16.7 | | |
| M^{ep}D^{ep}₃D₁₅M^{ep} | | | | | | 16.7 | |
| M^{ep}D^{ep}₃D₁₅M^{ep} | | | | | | | 16.7 |

100 grams of each formula was blended with a 46% solution of an amine or amide curing agent (EpiKure 8290) available from Hexion Specialty Corporation in water as shown in Table VIII.

TABLE VIII

| | Formula | | | | | | |
|---|---|---|---|---|---|---|---|
| | G | H | I | J | K | L | M |
| Curing agent | 24.5 | 28.4 | 30.0 | 27.2 | 34.1 | 34.1 | 34.1 |

### Pencil Hardness

The blends were then coated onto an aluminum plate and allowed to cure at room temperature. Pencil hardness was then measured according to ASTM D3363 over time with the results shown in Table IX.

TABLE IX
Pencil Hardness

| Example | 1 day | 13 days | 7 days |
|---|---|---|---|
| 6G | 5B | HB | F |
| 6H | 5B | HB | F |
| 6I | 5B | HB | F |
| 6J | 5B | HB | F |
| 6K | 4B | HB | F |
| 6L | 4B | HB | F |
| 6M | 4B | HB | F |
| Silicone Release Coating | Softer than 6B | | |

### Surface Energy by Roll-Off-Angle

The surface energy of each coating was measured using the roll-off-angle as shown in Table X.

TABLE X
Roll-Off-Angle

| Sample | Roll-Off-Angle |
|---|---|
| 6G | 20.9 |
| 6H | 23.6 |
| 6I | 19.9 |
| 6J | 26.3 |
| 6K | 17.5 |
| 6L | 17.5 |
| 6M | 17.5 |
| Silicone Release Coating | 17.5 |
| Gel Coat | 41.5 |
| Epoxy Anti-corrosion | 49.2 |

The low roll-off-angles demonstrate the low surface energy of the coatings of this invention compared with a soft, all silicone release coating. The coatings are considerably lower than a polyester gel coat, or an epoxy anticorrosion coating thus providing good release.

### Example 6

62.3 grams of an alkoxylated bis-phenol A epoxy resin dispersed in water (solids epoxy equivalent weight 520), 16.7 grams of 3-epoxy cyclohexyl ethyl terminated polydimethylsiloxane (eq. wt. 950), 5.0 grams of Doversperse A-1 from Dover Chemical Corporation, 2.2 grams of phthalo blue from Plasticolours, 6.0 grams of Novacite L-337 from Malvern, 0.5 grams of polyether modified polydimethylsiloxane (BYK 333) and 9.6 grams of water were blended to form an emulsion. 102.3 grams of this solution was mixed with 25.5 grams of a solution of an amine or amide curing agent (EpiKure 8290-Y-60) from Hexion Specialty Corporation and water that had been blended in a 75 to 15 ratio.

A second solution was prepared for use as a clear top coat. 62.3 grams of an alkoxylated bis-phenol A epoxy resin dispersed in water (solids epoxy equivalent weight 520), 16.7 grams of 3-epoxy cyclohexyl ethyl terminated polydimethylsiloxane (eq. wt. 950), 0.5 grams of polyether modified polydimethylsiloxane (BYK 333), 1.0 grams of DC 3-0133 from Dow Corning, 2.5 grams of Aerodisp W740X from Evonik Industries, and 17.1 grams of water were blended to form an emulsion. 100 grams of this solution was mixed with 25 grams of a solution of an amine or amide curing agent (EpiKure 8290-Y-60) from Hexion Specialty Corporation and water that had been blended in a 75 to 15 ratio.

This reactive solution was coated onto a gel coated coupon and allowed to cure at room temperature. The one half of the coupon was sanded with 600 grit sand paper. Half of the sanded portion was given the top coat listed above. The coated coupon was then immersed in the ocean at Punta Gorda Fla. Results are shown in Table XI.

TABLE XI

| Punta Gorda | Month 1 | Month 2 | Month 3 | Month 4 | Month 6 |
|---|---|---|---|---|---|
| Unsanded | Easy Clean | Easy Clean | Easy Clean | Cleans Well | Cleans Well |
| Sanded | Easy Clean | Easy Clean | Easy Clean | Cleans Well | Cleans Well |
| Sanded with | Easy Clean | Easy Clean | Easy Clean | Cleans Well | Cleans Well |
| Top Coat | | | | | |

| | Pencil Hardness After 6 Month Emersion |
|---|---|
| Unsanded | F |
| Sanded | F |
| Sanded with | F |
| Top Coat | |
| | Roll-Off-Angle After 6 Months Emersion |
| Unsanded | 23.6 |
| Sanded | 24.7 |
| Sanded with | 24.7 |
| Top Coat | |

### Example 7

Coatings were formulated using an alkoxylated bis-phenol A epoxy resin dispersed in water (solids epoxy equivalent weight 520), 3-epoxy cyclohexyl ethyl terminated polydimethylsiloxane (eq. wt. 950), epoxide-functional polydimethylsiloxane copolymer designed for use as a photocurable release agent (UV 9300) available from Momentive Specialty Chemicals, polyether modified polydimethylsiloxane (BYK 333), phthalo blue from Plasticolours, Water, Novacite L337 401v, Doversperse A1 and Paroil 63NR (both from Dover Chemical Co) and varied amounts of a silicone copolymer, nonionic surfactant, propylene glycol blend (A1100) from Momentive Performance Materials as shown in Table XII.

TABLE XII

| Formula | N | O | P | Q |
|---|---|---|---|---|
| Epoxy Resin | 62.3 | 62.3 | 62.3 | 62.3 |
| epoxide-functional | 16.7 | 16.7 | 16.7 | 16.7 |
| polydimethylsiloxane | | | | |
| Polyether Modified | 0.5 | 0.5 | 0.5 | 0.5 |
| Polydimethylsiloxane | | | | |
| (BYK 333) | | | | |
| Phthalo blue | 1.0 | 1.0 | 1.0 | 1.0 |
| Water | 14.6 | 14.6 | 14.6 | 14.6 |
| Novacite L337 401V | 6.0 | 6.0 | 6.0 | 6.0 |
| Doversperse A-1 | 5.0 | 5.0 | 5.0 | 5.0 |
| Paroil 63NR | 2.0 | 2.0 | 2.0 | 2.0 |
| surfactant | 0.0 | 0.1 | 0.5 | 1.0 |

Each formula was mixed with 25 grams of a solution of EpiKure 8290 diluted in water at a 75 to 15 ratio. The solutions were then coated onto aluminum coupons and subjected to ocean testing in Punta Gorda, Fla. The results are shown in Table XIII.

TABLE XIII

| Punta Gorda | Month 1 |
|---|---|
| 7N | Clean Easily |
| 7O | Clean Easily |
| 7P | Clean Easily |
| 7Q | Clean Easily |

### Example 8

31.13 grams of a bis-phenol A epoxy resin dispersed in water with 2-propoxyethanol, 8.48 grams of a 3-epoxy cyclohexyl ethyl terminated polydimethylsiloxane (eq. wt. 950), 0.5 grams of polyether modified polydimethylsiloxane (BYK 333), and 0.5 grams of a water dispersed pigment were added to a flask and blended. 9.65 grams of water was added and the blend mixed. 12.5 grams of an aliphatic poly amine (eq. wt. 163)(Epicure 8290) diluted to 50% in water was added and the mixture stirred. This was painted onto an aluminum coupon and allowed to cure at room temperature.

The resulting coating had a pencil hardness of 2B after seven days, and HB after three weeks aging at room temperature.

### Example 9

33.3 grams of Bisphenol A epichlororhydrin (eg. wt. 192-207), 16.6 grams of a 3-epoxy cyclohexyl ethyl terminated polydimethylsiloxane (eq. wt. 950), and 0.9 grams of a polyether modified polydimethylsiloxane were mixed. 66.6 grams of a (60%) aliphatic poly amine (eq. wt. 163) solution was added and the solution stirred. The mixture was painted onto an aluminum coupon and allowed to cure at room temperature.

The resulting coating had a pencil hardness of HB after seven days, and HB after three weeks aging at room temperature.

The coatings of the present teachings may be painted on walls where easy cleaning and water resistance and repellency are important. Specifically the coatings of the present teachings have been applied onto a water amusement park wall. Alternatively, the coatings of the present teachings have been applied onto surfaces where slipperiness, easy cleaning and durability are important, e.g., non-limiting examples include slides for postal service and ups package handling areas.

In one embodiment, the group CHR¹³OCR¹⁴R¹⁵ of the coating of the present teachings may be a polyepoxy group or a polypropoxy group, resulting in epoxy, propoxy and mixed epoxypropoxy poly ethers.

In one embodiment, an article of manufacture may be made from the coating of embodiment the present teachings. The article may include, but is not limited to, sheets, films, multilayer sheets, multilayer films, molded parts, extruded profiles, fibers, coated parts. The coated parts may include, without limitation, boat hulls, buoys, petroleum dereks, and water intakes. The coated parts may be in non-aqueous or non-marine environments, e.g., coated onto walls of buildings, and mail chutes, etc.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying embodiments.

We claim:

1. A coating, comprising:
1-99 parts of an organic epoxy;
99-1 parts of an alkylepoxysiloxane II, having the following structure (II)
(R¹R²R³SiO_{1/2})ₐ(R⁴R⁵R⁶SiO_{1/2})_{b}(R⁷R⁸SiO_{2/2})_{c}(R⁹R¹⁰SiO_{2/2})_{d}(R¹¹SiO_{3/2})ₑ(R¹²SiO_{3/2})_{f}(SiO_{4/4})_{g} (II)
wherein each R¹ to R¹² are each independently a hydrogen, an alkyl group containing 1-30 carbon atoms, an aryl group, an alkaryl group containing 1-30 carbons, and an CHR¹³OCR¹⁴R¹⁵ group,
wherein at least one R¹ to R¹² is CHR¹³OCR¹⁴R¹⁵, and
R¹³ is independently an alkylene group of 1 to 30 carbons, or one or more hetero atoms such as oxygen, sulfur, or nitrogen, and
each R¹⁴, and R¹⁵ is independently a hydrogen atom, an alkyl group or an aryl group; or
R¹³ and either R¹⁴ or R¹⁵ are linked to form a three- to eight-membered cyclic group,
wherein a through g are each individually 0 to 200, and a+b+c+d+e+f+g≧2; and
1-50 parts of a curing agent.

2. The coating composition of claim 1, wherein the organic epoxy, the alkylepoxysiloxane and the curing agent are in an emulsion with water.

3. The coating composition of claim 1, wherein the organic epoxy is an alkylene oxide adduct prepared from compounds containing an average of more than one hydroxyl groups.

4. The coating composition of claim 3, wherein the oxide adducts are selected from the group consisting of ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, and combinations thereof.

5. The coating of claim 3, wherein the alkylene oxide adduct is produced from reaction of an epihalohydrin and compounds having an average of more than one hydroxyl group.

6. The coating composition of claim 3, wherein the alkylene oxide adduct is selected from the group consisting of the reaction products of epichlorohydrin and bisphenol A, epichlorohydrin and phenol, epichlorohydrin and biphenol, epichlorohydrin and an amine, epichlorohydrin and a carboxylic acid, and an epoxide prepared by oxidation of an aliphatic or aromatic olefin or alkyne.

7. The coating of claim 3, wherein the alkylene oxide adduct is produced from reaction of an epihalohydrin and compounds selected from the group consisting of aliphatic alcohols, aliphatic diols, polyether diols, polyether triols, polyether tetrols, and combination thereof.

8. The coating of claim 4, wherein the phenol is selected from the group consisting of dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (i.e. the reaction product of phenols and simple aldehydes, preferably formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, and combinations thereof.

9. The coating of claim 4, wherein the phenol is selected from the group consisting of bisphenols, halogenated bisphenols, hydrogenated bisphenols, novolac resins, and polyalkylene glycols, and combinations thereof.

10. The coating of claim 4, wherein the phenol is selected from the group consisting of resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins, tetramethylbiphenol, tetramethyl-tetrabromobiphenol, tetramethyltribromobiphenol, tetrachlorobisphenol A, and combinations thereof.

11. The coating of claim 6, wherein the carboxylic acid preferably has a C₁-C₄₀ hydrocarbon backbone.

12. The coating of claim 11, wherein the C₁₀-C₄₀ hydrocarbon backbone is a straight- or branched-chain alkane or alkene, optionally containing oxygen.

13. The coating of claim 6, wherein the carboxylic acid is selected from the group consisting of phthalic acid, isophthalic acid, terephthalic acid, tetrahydro- and/or hexahydrophthalic acid, endomethylenetetrahydrophthalic acid, isophthalic acid, methylhexahydrophthalic acid, and combinations thereof.

14. The coating of claim 6, wherein the carboxylic acid is selected from the group consisting of caproic acid, caprylic acid, capric acid, octanoic acid, VERSATIC™ acids, available from Resolution Performance Products LLC, Houston, Tex., decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

15. The coating of claim 1, wherein at least one of the organic epoxy ingredient, the siloxane epoxy ingredient and the curing agent ingredient has been emulsified with water prior to being directly blended with the other ingredients and being applied to a substrate.

16. The coating of claim 1, wherein the organic epoxy and siloxane epoxy are emulsified in water, and the curing agent has been blended directly into the epoxy and siloxane epoxy emulsion.

17. The coating of claim 1, wherein the curing agent is emulsified in water prior to being mixed with the epoxy and siloxane epoxy emulsion or the curing agent is directly blended with the epoxy and siloxane epoxy emulsion.

18. The coating of claim 1, comprising an emulsifying agent selected from the group consisting of fatty alcohols, polyoxyethylene glycol alkyl ethers: CH₃—(CH₂)₁₀₋₁₆—(O—C₂H₄)₁₋₂₅—OH, glucoside alkyl ethers: CH₃—(CH₂)₁₀₋₁₆—(O-glucoside)₁₋₃-OH, polyoxyethylene glycol octylphenol ethers: C₈H₁₇—(C₆H₄)—(O—C₂H₄)₁₋₂₅—OH, polyoxyethylene glycol alkylphenol ethers: C₉H₁₉—(C₆H₄)—(O—C₂H₄)₁₋₂₅—OH, glycerol alkyl esters, polyoxyethylene glycol sorbitan alkyl esters, sorbitan alkyl esters, cocamide MEA, cocamide DEA, dodecyl dimethylamine oxide; block copolymers of polyethylene glycol and polypropylene glycol, and silicone surfactants.

19. The coating of claim 18, wherein the fatty alcohol is selected from the group consisting of oleyl alcohol, cetyl alcohol, stearyl alcohol, and combinations thereof.

20. The coating of claim 18, wherein the polyoxypropylene glycol alkyl ethers are selected from the group consisting of octaethylene glycol monododecyl ether and pentaethylene glycol monododecyl ether.

21. The coating of claim 18, wherein the glucoside of the glucosidal ether is selected from the group consisting of decyl glucoside, lauryl glucoside and octyl glucoside.

22. The coating of claim 18, wherein the polyoxyethylene glycol octylphenol ether is Triton X-100.

23. The coating of claim 18, wherein the polyoxyethylene glycol alkylphenol ethers is Nonoxynol-9.

24. The coating of claim 18, wherein the glycerol alkyl ester is glyceryl laurate.

25. The coating of claim 18, wherein the polyoxyethylene glycol sorbitan alkyl ester is a polysorbate.

26. The coating of claim 18, wherein the silicone surfactants are selected from the group consisting of polyepoxysilicone, and polypropoxysilicone block co-polymers.

27. The coating of claim 1, wherein the curing agent is an amine and is selected from the group consisting of diaminodiphenylmethane, aminophenol, xylene diamine, anilines, and combinations thereof.

28. The coating of claim 1, wherein the curing agent is an amine and is selected from the group consisting of ethylene diamine, diethylene triamine, polyoxypropylene diamine, triethylene tetramine, dicyandiamide, melamine, cyclohexylamine, benzylamine, diethylaniline, methylenedianiline, m-phenylenediamine, diaminodiphenylsulfone, 2,4 bis(p-aminobenzyl)aniline, piperidine, and N,N-diethyl-1,3-propane diamine.

29. The coating of claim 1, wherein the curing agent is an amine and is a polyamidoamines formed by reaction of a dicarboxylic acid and a polyamine, wherein the dicarboxylic acid is selected from the group consisting of 1,10-decanedioic acid, 1,12-dodecanedioic acid, 1,20-eicosanedioic acid, 1,14-tetradecanedioic acid, 1,18-octadecanedioic acid and dimerized and trimerized fatty acids, and the polyamines are selected from the group consisting of aliphatic and cycloaliphatic polyamines such as ethylene diamine, diethylene triamine, triethylene tetramine, tetraethylene pentamine, 1,4-diaminobutane, 1,3-diaminobutane, hexamethylene diamine, and 3-(N-isopropylamino)propylamine.

30. The coating of claim 1, wherein the curing agent is an amide and is a polyamide derived from the reaction of aliphatic polyamines containing no more than 12 carbon atoms and polymeric fatty acids obtained by dimerizing and/or trimerizing ethylenically unsaturated fatty acids containing up to 25 carbon atoms.

31. The coating of claim 1, wherein the curing agent is an amine and is selected from the group consisting of aliphatic polyamines, polyglycoldiamines, polyoxypropylene diamines, polyoxypropylenetriamines, amidoamines, imidazoles, reactive polyamides, ketimines, araliphatic polyamines (i.e. xylylenediamine), cycloaliphatic amines (i.e. isophoronediamine or diaminocyclohexane), menthane diamine, 4,4-diamino-3,3-dimethyldicyclohexylmethane, heterocyclic amines (aminoethyl piperazine), aromatic polyamines (methylene dianiline), diamino diphenyl sulfone, mannich base, phenalkamine, and N,N′,N″-tris(6-aminohexyl)melamine.

32. The coating of claim 1, wherein the organic epoxy is the reaction product of a polyepoxide and a compound containing more than one isocyanate moiety or a polyisocyanate.

33. The coating of claim 1, wherein the organic epoxy is the reaction product of a polyepoxide and a compound containing more than one isocyanate moiety or a polyisocyanate.

34. The coating of claim 33, wherein the organic epoxy produced in such a reaction is an epoxy-terminated polyoxazolidone.

35. The coating of claim 1, wherein CHR¹³OCR¹⁴R¹⁵ is represented by the following structure III:

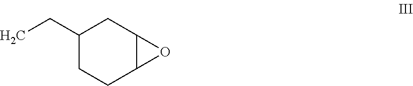

36. The coating of claim 1, wherein CHR¹³OCR¹⁴R¹⁵ is selected from the group consisting of polyepoxy and polypropoxy.

37. The coating of claim 1, wherein the coating has an easy release surface toward marine organisms that may wish to attach to a coated substrate.

38. The coating of claim 37, wherein the easy release results from the coating providing a low surface energy between about 17 to 30 dynes/cm.

39. An article made from the coating of claim 38.

40. The article of claim 39, wherein the article is selected from the group consisting of sheets, films, multilayer sheets, multilayer films, molded parts, extruded profiles, fibers, coated parts.

41. The article of claim 40, wherein the coated parts are selected from the group consisting of boat hulls, buoys, petroleum dereks, and water intakes.

42. The article of claim 41, wherein the coated parts are in non-aqueous or non-marine environments.

43. The article of claim 42, wherein the coated parts are selected from the group consisting of walls of buildings, and mail chutes.

44. The article of claim 39, wherein the article is selected from sheets, films, multilayer sheets, multilayer films, molded parts, extruded profiles, fibers, coated parts.

45. A method for coating a substrate, comprising:
blending an epoxy siloxane, an epoxy organic compound and an amine or amide compound;
coating a substrate with the blend; and
curing the coating.

46. The method of claim 45, wherein the substrate is the hull of a ship.

47. The method of claim 45, wherein the cured coating is a hard, low energy epoxypolysiloxane/organic epoxy coating that is sandable.

48. The method of claim 45, wherein the cured coating is a hard, low energy epoxypolysiloxane/organic epoxy coating is repairable.

49. The method of claim 45, wherein the cured coating is a hard, low energy epoxypolysiloxane/organic epoxy coating is chemically stable to the marine environment.

50. The method of claim 45, wherein the cured coating is a hard, low energy epoxypolysiloxane/organic epoxy coating is a block copolymer or interpenetrating network.

51. The method of claim 45, comprising emulsifying at least one of the organic epoxy ingredient, the siloxane epoxy ingredient and the curing agent ingredient with water prior to being directly blended with the other ingredients and being applied to a substrate.

52. The method of claim 45, comprising emulsifying the organic epoxy and siloxane epoxy in water, and blending the curing agent directly into the epoxy and siloxane epoxy emulsion.

53. The method of claim 45, comprising emulsifying the curing agent in water prior to being mixed with the epoxy and siloxane epoxy emulsion or directly blending the curing agent with the epoxy and siloxane epoxy emulsion.
